(19) United States
(12) Patent Application Publication
(10) Pub. No.: US 2015/0372274 A1
(43) Pub. Date: Dec. 24, 2015

(54) SEPARATOR COATED WITH POLYMER AND CONDUCTIVE SALT AND ELECTROCHEMICAL DEVICE USING THE SAME

(71) Applicant: SOLVAY SA, Brussels (BE)

(72) Inventors: Christine HAMON, Bollate (IT); Riccardo PIERI, Milano (IT); Shilei CHEN, Brussels (BE); Marc-David BRAIDA, Bry Sur Marne (FR); Jean-Francois MOUSSET, Morlhon-le-Haut (FR)

(21) Appl. No.: 14/646,560

(22) PCT Filed: Nov. 20, 2013
(86) PCT No.: PCT/EP2013/074250

§ 371 Date: May 21, 2015

(30) Foreign Application Priority Data
Nov. 21, 2012 (EP) 12306450.3

(51) Int. Cl. H01M 2/16; H01M 2/14

(52) U.S. Cl. CPC H01M 2/1686; H01M 2/1653; H01M 2/145

(57) ABSTRACT

The present invention provides method for manufacturing a coated separator for use in an electrochemical device, comprising the steps of: (i) providing a separator having two surfaces; (ii) applying a coating composition [composition (C)] on at least one surface of the separator, the composition (C) comprising a polymer [polymer (P)] and at least one electrolyte salt [salt (E)] of formula (a), A⁺B⁻ (a) wherein A⁺ indicates an ion selected from alkaline metal cations or a combination thereof, and B″ indicates an ion selected from anions or a combination thereof, so as to obtain a coating layer onto said surface; and (ii) drying the coating layer so as to obtain a coated separator, wherein the polymer (P) is a vinylidene fluoride (VdF) polymer and comprises recurring units derived from at least one comonomer (C), said comonomer (C) being different from vinylidene fluoride (VdF), and wherein the polymer (P) comprises recurring units derived from at least one (meth)acrylic monomer (MA). Further, the present provides a separator for use in an electrochemical device, said separator being coated on at least one surface thereof a coating comprising a polymer (P) and at least one salt (E) as described above, wherein said coating is characterized by: a dry thickness of from about 0.1 to 10 μm; a weight between 5 and 100% of the weight of the un-coated separator; or being substantially solvent free. Moreover, the present invention provides a method for producing an electrochemical device using the coated separator as described above.

### CROSS-REFERENCE TO RELATED APPLICATION

The present application claims priority to European application No. 12306450.3 filed on Nov. 21, 2012, the whole content of this application being incorporated herein by reference. Should the disclosure of any patents, patent applications, and publications which are incorporated herein by reference conflict with the description of the present application to the extent that it may render a term unclear, the present description shall take precedence.

### TECHNICAL FIELD

The present invention relates to a separator coated by a polymer and a conductive salt on one or both sides thereof, as well as an electrochemical device including the separator and a production method thereof.

### BACKGROUND ART

A storage battery is composed of at least one electrochemical cell enclosed in a housing structure. Typically, an electrochemical cell comprises an anode, a cathode, an electrolyte, and a separator. The separator is placed in the cell to separate the anode and cathode while freely permitting the electrolyte movement and ion transfer.

One commercially available battery separator is a microporous polyolefin membrane which is made permeable to ionic flow but preventing electric contact between the anode and cathode. Additionally, to meet the requirement of a high performance battery in the current technology age, the separator needs to have a balance of other critical properties. Firstly, the separator is required to be extremely thin (generally less than 40 μm) and have long-term physical stability. Secondly, the separator must be resistant to the highly acidic or basic electrolyte employed in the electrochemical cell, to withstand chemical degradation under ambient and elevated temperatures. Moreover, a good microporous separator should be able to retain, in its micropores, a significant amount of electrolyte when the electrochemical cell is in operation, to minimize cell internal resistance.

Furthermore, one important measure of a good battery separator is that the separator should be wetted quickly by the electrolyte, to reduce the electrolyte filling time and provide an optimum battery working condition by decreasing the separator and cell resistance. As such, for a large number of batteries where polar organic electrolytes are employed, their separator is required to have a hydrophilic electrolyte-contacting surface.

For this reason, while olefin materials such as polyethylene, polypropylene or laminates thereof have been widely used for fabricating the microporous battery separators, they are typically of hydrophobic nature and often need a surface modification to have a satisfactory “wettability” for particular battery applications.

In this regard, U.S. Pat. No. 4,110,143 (W. R. GRACE & CO.) 29, Aug. 1978 discloses a process for forming a wettable battery separator comprising a non-woven mat of polyolefin fiber, comprising contacting the mat with an aqueous solution of a water-soluble peroxy compound at a temperature below 70° C., rinsing the mat in water and thereafter immersing the thus treated mat in an aqueous solution of a hydrophilic vinyl monomer, said solution containing a redox catalyst thereby causing a graft polymerization of said hydrophilic vinyl monomer on said polyolefin mat, to give a wettable separator surface.

U.S. Pat. No. 4,359,510 (CELANESE CORPORATION) 16, Nov. 1982 describes a hydrophilic open-celled microporous membrane comprising a normally hydrophobic microporous polyolefin membrane, having deposited on at least one surface thereof a polymer coating of cellulose ester or polyvinyl alcohol, and a surfactant disposed within said coated microporous membrane in a manner and in an amount sufficient to render the substrate microporous membrane hydrophilic.

Similarly, U.S. Pat. No. 6,472,105 B (MITSUBISHI ELECTRIC CORP) 29, Oct. 2002 discloses an adhesive adhered to a battery separator for improving wetting properties thereof, the adhesive comprising: a thermoplastic resin, a solvent capable of dissolving said thermoplastic resin, and a surface active agent including polysiloxane skeleton. In the working examples thereof, the adhesive was prepared by adding a surface active agent to a homogenous mixture of polyvinylidene fluoride (PVDF) resin and N-methyl-2-pyrrolidone (NMP), and was subsequently applied to both sides of a porous polypropylene sheet used as a separator.

Moreover, US 2007/0054184 A (LG CHEM, LTD.) 8, Mar. 2007 mentions a battery separator in which an electrolyte-soluble polymer is coated on one or both surfaces of the separator, so that the coated polymer can be dissolved in the electrolyte after assembling of the battery to produce either a gel electrolyte close to a liquid phase or a highly viscous liquid electrolyte. US 2007/0054184 further describes that, for making such a coated separator, the electrolyte-soluble polymer is dissolved in a suitable solvent, and then, the polymer solution is coated on one or both sides of the separator and dried by volatilization of the solvent.

However, while the aforementioned prior art documents provide a few polymer coatings that would to a certain extent improve the wettability of a porous separator, there is still a need in the art for an improved porous separator which combines superior wettability with the potential to retain more electrolytes, to reduce electrolyte filling time and minimize cell internal resistance for better battery performance.

### SUMMARY OF INVENTION

In one aspect, the present invention provides a method for manufacturing a coated separator for use in an electrochemical device, comprising the steps of:

(i) providing a separator having two surfaces;
(ii) applying a coating composition [composition (C)] on at least one surface of the separator, the composition (C) comprising a polymer [polymer (P)] and at least one electrolyte salt [salt (E)] of formula (a), A⁺B⁻ (a)
wherein A⁺ indicates an ion selected from alkaline metal cations or a combination thereof, and B⁻ indicates an ion selected from anions or a combination thereof, so as to obtain a coating layer onto said surface; and
(ii) drying the coating layer so as to obtain a coated separator, wherein the polymer (P) is a vinylidene fluoride (VdF) polymer and comprises recurring units derived from at least one comonomer (C), said comonomer (C) being different from vinylidene fluoride (VdF), and wherein the polymer (P) comprises recurring units derived from at least one (meth)acrylic monomer (MA) having formula (I):

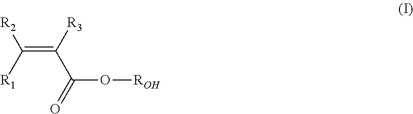

wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group.

In another aspect, the present invention provides a separator for use in an electrochemical device, wherein said separator is coated on at least one surface thereof a coating comprising the polymer (P) and at least one salt (E), said coating having a dry thickness of from about 0.1 to 10 μm.

In still another aspect, the present invention provides a separator for use in an electrochemical device, wherein said separator is coated on at least one surface thereof a coating comprising the polymer (P) and at least one salt (E), and wherein the coating has a weight that is between 5 and 100% of the weight of the un-coated separator.

In still another aspect, the present invention provides a separator for use in an electrochemical device, wherein said separator is coated on at least one surface thereof a coating comprising the polymer (P) and at least one salt (E), said coating being substantially solvent free.

In a still further aspect of the present invention, there is provided a method for producing an electrochemical device, the method comprising the steps of:

(1) providing a separator having two surfaces and applying a coating composition (C) on at least one surface of the separator, so as to obtain a coated separator;
(2) interposing the coated separator produced in step (1) between a cathode and an anode to produce an electrochemical device; and,
(3) injecting an electrolyte into the electrochemical device.

The Applicant has found that, when a separator surface is coated by a coating comprising a polymer (P) and at least one salt (E) as described above, the coated separator is wetted faster by the electrolyte and the salt (E) contained in the coating can be dissolved in the electrolyte after assembly of the electrochemical device. Particularly, the inventive coated separator according to the present invention allows one to use an electrolyte solution with lower salt concentration for filling the electrochemical cell. Moreover, the subsequent release of conductive salt from the inventive coating to the electrolyte will further increase the conductive ion concentration in the cell, thereby optimizing the battery performance. Moreover, the combination of a standard electrolyte with a coated separator according to the present invention, which contains both polymer and electrolyte salt in its coating, provides an additional chemical/physical stability advantage over the existing polymer-coated separators, as discovered by the Applicant.

For the purpose of the present invention, the term “separator” is intended to denote a discrete, generally thin, interface in an electrochemical device, to prevent direct contact between the anode and the cathode while freely allowing the permeation of electrolyte-derived ions. This interface may be homogeneous, that is, completely uniform in structure (dense separator), or it may be chemically or physically heterogeneous, for example containing voids, pores or holes of finite dimensions (porous separator).

As the separator on which a coating composition (C) as above-defined is applied according to the invention, any conventional battery separator can be selected. Preferably, a porous separator is used. Examples of the suitable polymer material for fabricating the porous separator according to the present invention include, but not limited to, polyethylene terephthalate, polybuthylene terephthalate, polyester, polyacetal, polyamide, polycarbonate, polyimide, polyetheretherketone, polyethersulfone, polyphenylene oxide, polyphenylene sulfide, polyethylene naphathalene, polyethylene, polypropylene, ethylene-butene copolymers, ethylene-propylene copolymers, VdF polymers (e.g. polyvinylidene fluoride and polyvinylidene fluoride-hexafluoropropylene copolymer), polyethylene oxide, polyacrylonitrile, polyethylene, polypropylene or combinations thereof. Preferably, the porous separators according to the present invention are made of polyethylene, polypropylene, PVDF or laminates thereof.

The porous separator used for the purpose of the present invention has a porosity (ε) of advantageously at least 5%, preferably at least 10%, more preferably at least 20% and advantageously of at most 90%, preferably at most 80%, wherein said “porosity” is a measure of the fraction of the void volume in the porous separator.

The porous separator used for the purpose of the present invention has a pore diameter (d) of advantageously at least 0.01 μm, preferably at least 0.05 μm, more preferably at least 0.1 μm and advantageously of at most 30 μm, preferably at most 10 μm.

The porous separator according to the present invention is preferably a microporous flat-sheet membrane or a non-woven cloth. “Microporous”, as used herein, is intended to describe a porous membrane or film in which the details of pore configuration or arrangement are discernible only by microscopic examination. The microporous flat-sheet membrane has a thickness usually of about 25 μm or less, a porosity usually ranging between 40% and 70% and an average pore diameter usually ranging from 0.01 μm to 1 μm. In a specific embodiment of the present invention, the separator is made of polypropylene microporous flat-sheet membrane.

The non-woven cloth is typically a felt or mat wherein fibers are randomly laid down to form numerous voids, said felt or matt having a thickness usually ranging from 80 μm to 300 μm, a porosity usually ranging from 60% to 80% and an average pore diameter usually ranging from 10 μm to 50 μm.

The microporous membrane is made typically either by a dry process or by a wet process. Both processes contain an extrusion step to produce a thin film and employ one or more orientation steps to generate pores. These processes are only applicable to molten or soluble polymers.

As mentioned earlier, the polymer (P) used in the present invention is a vinylidene fluoride (VdF) polymer and comprises recurring units derived from at least one comonomer (C), said comonomer (C) being different from vinylidene fluoride (VdF),

and wherein the polymer (P) comprises recurring units derived from at least one (meth)acrylic monomer (MA) having formula (I):

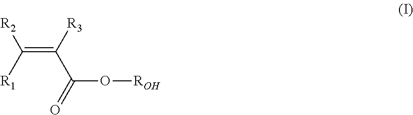

wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group.

For the purpose of the present invention, by “vinylidene fluoride (VdF) polymer” it is intended to denote a polymer comprising recurring units derived from vinylidene fluoride (VdF).

The polymer (P) comprises typically at least 50% by moles, preferably at least 70%, more preferably at least 80% by moles of recurring units derived from vinylidene fluoride (VdF).

The polymer (P) further comprises recurring units derived from at least one comonomer (C), said comonomer (C) being different from vinylidene fluoride (VdF).

The comonomer (C) can be either a hydrogenated comonomer [comonomer (H)] or a fluorinated comonomer [comonomer (F)].

By the term “hydrogenated comonomer [comonomer (H)]”, it is hereby intended to denote an ethylenically unsaturated comonomer free of fluorine atoms.

Non-limitative examples of suitable hydrogenated comonomers (H) include, notably, ethylene, propylene, vinyl monomers such as vinyl acetate, as well as styrene monomers, like styrene and p-methylstyrene.

By the term “fluorinated comonomer [comonomer (F)]”, it is hereby intended to denote an ethylenically unsaturated comonomer comprising at least one fluorine atom.

The comonomer (C) is preferably a fluorinated comonomer [comonomer (F)].

Non-limitative examples of suitable fluorinated comonomers (F) include, notably, the followings:

(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins such as vinyl fluoride, 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE);
(e) (per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
(g) fluoroalkyl-methoxy-vinylethers of formula CF₂═CFOCF₂OR_{f2}, wherein R_{f2} is a C₁-C₆ fluoro- or perfluoroalkyl group, e.g. —CF₃, —C₂F₅, —C₃F₇ or a C₁-C₆ (per)fluorooxyalkyl group having one or more ether groups, e.g. —C₂F₅—O—CF₃;
(h) fluorodioxoles of formula:

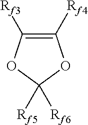

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃.

Most preferred fluorinated comonomers (F) are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride.

Typically, the polymer (P) comprises typically from 1% to 40% by moles, preferably from 2% to 35% by moles, more preferably from 3% to 20% by moles of recurring units derived from at least one comonomer (C).

As aforementioned, the polymer (P) comprises recurring units derived from at least one (meth)acrylic monomer (MA) having formula (I) here below:

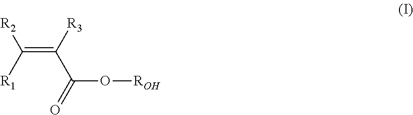

wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group.

The Applicant has surprisingly found that, by selecting a VdF polymer (P) which comprises recurring units derived from at least one (meth)acrylic monomer (MA), the resulted polymer/salt composition (C) could advantageously provide a coated separator with superior coating adhesion and therefore more physically stable, compared to other VdF polymers.

Typically, the polymer (P) comprises at least 0.01% by moles, preferably at least 0.02% by moles, more preferably at least 0.03% by moles of recurring units derived from at least one (meth)acrylic monomer (MA) having formula (I) as described above.

Further, the polymer (P) typically comprises at most 10% by moles, preferably at most 5% by moles, more preferably at most 2% by moles of recurring units derived from at least one (meth)acrylic monomer (MA) having formula (I) as described above.

The (meth)acrylic monomer (MA) preferably complies with formula (II) here below:

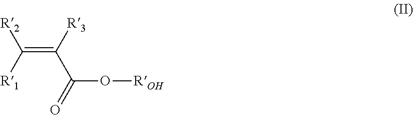

wherein:
R′₁, R′₂ and R′₃ are hydrogen atoms, and
R′_{OH} is a hydrogen atom or a C₁-C₅ hydrocarbon moiety comprising at least one hydroxyl group.

Non-limitative examples of (meth)acrylic monomers (MA) include, notably, acrylic acid, methacrylic acid, hydroxyethyl(meth)acrylate, hydroxypropyl(meth)acrylate, hydroxyethylhexyl(meth)acrylate.

The (meth)acrylic monomer (MA) is more preferably selected from the followings:
hydroxyethyl acrylate (HEA) of formula:

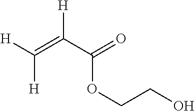

2-hydroxypropyl acrylate (HPA) of either of formulae:

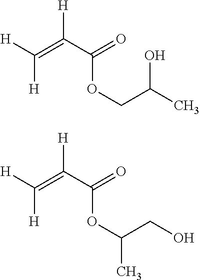

acrylic acid (AA) of formula:

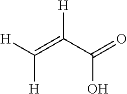

and mixtures thereof.

The (meth)acrylic monomer (MA) is even more preferably acrylic acid (AA) or hydroxyethyl acrylate (HEA).

The salt (E) of the present invention complies with the formula of A⁺B⁻ (a), wherein:

A⁺ indicates an ion selected from alkaline metal cations, such as Li⁺, Na⁺, K⁺ and Cs⁺, or a combination thereof, and
B⁻ indicates an ion selected from anions or a combination thereof, such as:
(1) PF₆⁻, ClO₄⁻, AsF₆⁻, BF₄⁻, AlCl₄⁻, SbF₆⁻, SCN⁻, C[CF₃SO₂]⁻, CF₃CO₂⁻, AsF₆⁻, B₁₀Cl₁₀;
(2) anions of formula R_{g0}SO₃⁻, wherein R_{g0} is a perfluoroalkyl group having between 1 and 12 carbons, such as CF₃SO₃⁻;
(3) anions of formula [R_{g1}SO₂][R_{g2}SO₂]N⁻, in which R_{g1} and R_{g2} are equal to or different from each other, each independently a straight or branched perfluoroalkyl group having between 1 and 12 carbons, preferably of 1 to 3 atoms, such as [fluorosulfonyl][nonafluorobutanesulfonyl]imide (FNFSI⁻) and [FSO₂]₂N⁻;

### (4) B[3,5-[CF₃]₂C₆H₃]₄⁻, B[C₆F₅]₄⁻ and Al[OC[CF₃]₃]₄⁻;

(5) difluoro[oxalato]borate (DFOB⁻), bis[oxalato]borate (BOB⁻), tris[oxalato]phosphate (TOP⁻), tetrafluoro[oxalato]phosphate (TFO⁻), [C₂F₅]₃PF₃⁻ (FAP⁻), B[CN]₄⁻ (Bison⁻), and 4,5-dicyano-[2-trifluoromethyl]imidazolide (TDI⁻).

Other conventional conductive salts known for their use in electrolyte may also be used as salt (E) in the present invention, without deviating from the spirit and scope thereof.

In a preferred embodiment of the present invention, the salt (E) used is selected from lithium bis(trifluoromethanesulfonyl)imide (also referred to as LiTFSI or [CF₃SO₂]₂N⁻Li⁺) and lithium bis(fluorosulfonyl)imide (also referred to as LiFSI, or [FSO₂]₂N⁻Li⁺), both demonstrating outstanding chemical and thermal stability when used in electrolyte application.

As aforementioned, the present invention provides a method for manufacturing a coated separator for use in an electrochemical device, comprising the steps of:

(i) providing a separator having two surfaces;
(ii) applying a coating composition [composition (C)] on at least one surface of the separator, the composition (C) comprising a polymer [polymer (P)] and at least one electrolyte salt [salt (E)], so as to obtain a coating layer onto said surface; and
(ii) drying the coating layer so as to obtain a coated separator,
wherein the polymer (P) and salt (E) are as defined in the foregoing text.

In the composition (C), any effective amount of the salt (E) may be mixed with the polymer (P). Preferably, the amount of the salt (E) constitutes from about 25 to about 250%, preferably from about 50 to about 150%, and more preferably from about 100 to about 200%, by weight, based on the weight of the polymer (P) in the composition (C).

In one embodiment of the aforedescribed method invention, the composition (C) comprises the polymer (P) and at least one salt (E) in a solvent [solvent (S)], and the drying step (iii) comprises drying the coated separator by volatilization of the solvent (S). Examples of solvent (S) include, but not limited to, ketones such as acetone, methylethylketone, methylene choloride/methanol mixtures (e.g., 1:1 w/w), tetrahydrofuran (THF), methylene chloride, chloroform, dimethylformamide (DMF), N-methyl-2-pyrrolidone (NMP), cyclohexane, water or a mixture thereof. In an exemplary embodiment of the present invention, acetone is used as solvent (S).

If the composition (C) includes a solvent (S), the concentration of polymer (P) typically ranges from about 1% to about 25% and preferably from about 2% to about 15% by weight, and the concentration of salt (E) is typically from 5% to 60% by weight and preferably from 15% to 50% by weight, based on the total weight of composition (C).

Furthermore, the present invention provides a separator for use in an electrochemical device, wherein said separator is coated on at least one surface thereof a coating comprising the polymer (P) and at least one salt (E), said coating having a dry thickness of from about 0.1 to 10 μm, and preferably from 1 to 5 μm. In use, the dry thickness of said coating can be adjusted according to the desire to increase the hydrophilicity of the uncoated separator and the practical need to maintain a minimal dimension of the coated separator.

In still another aspect, the present invention provides a separator for use in an electrochemical device, wherein said separator is coated on at least one surface thereof a coating comprising a polymer (P) and at least one salt (E), and wherein the coating has a weight that is between 5 and 100%, preferably between 10 and 50% of the weight of the un-coated separator.

In still another aspect, the present invention provides a separator for use in an electrochemical device, wherein said separator is coated on at least one surface thereof a coating comprising a polymer (P) and at least one salt (E), said coating being substantially solvent free. As used herein, the term “substantially solvent-free” means not more than about 5 wt % of solvent exits in said coating, based on the coating dry weight.

Furthermore, the present invention provides a method for producing an electrochemical device, the method comprising the steps of:

(1) providing a separator having two surfaces and applying a coating composition (C) comprising the polymer (P) and at least one salt (E) on at least one surface of the separator, so as to obtain a coated separator;
(2) interposing the coated separator produced in step (1) between a cathode and an anode to produce an electrochemical device; and,
(3) injecting an electrolyte into the electrochemical device.

Preferably, in step (1) of the aforementioned method, the coating composition (C) is produced by mixing the polymer (P) and at least one salt (E) in a solvent (S), and then applied on one or both surfaces of the separator, optionally dried thereafter by volatilization of the solvent (S).

In step (2) of the aforementioned method, the separator produced in step (1) can be interposed between a cathode and an anode according to any conventional technique for assembling an electrochemical device, such as but not limited to a winding process, a lamination process and a folding process between the separator and the electrodes.

In step (3) of the aforementioned method, when the electrolyte is injected in the electrochemical device, the salt (E) contained in the coated separator produced in step (1) will be dissolved in the electrolyte, further increasing the concentration of conductive ions in the electrochemical cell, thereby optimizing the battery performance.

In step (3), the electrolyte used for injection comprises a charge carrying medium and at least one electrolyte salt, wherein the electrolyte salt is the same or different from the salt (E) in the composition (C).

As will be appreciated by those skilled in the art, the electrolyte may be in any convenient form including liquids and gels. A variety of charge carrying media may be employed in the electrolyte. Exemplary media are liquids or gels (e.g. solvating polymers such as poly(oxyethylene)) capable of solubilising sufficient quantities of metal salt and electrolyte salt coated on the separator, and optionally other ingredients or additives, so that a suitable quantity of charge can be transported between the cathode and anode in the electrode device.

Representative charge carrying media in the electrolyte include ethylene carbonate (EC), propylene carbonate (PC), dimethyl carbonate (DMC), diethyl carbonate (DEC), ethyl-methyl carbonate (EMC), butylene carbonate, vinylene carbonate, fluoroethylene carbonate, fluoropropylene carbonate, gamma-butyrolactone, methyl difluoroacetate, ethyl difluoroacetate, dimethoxyethane, diglyme (bis(2-methoxyethyl) ether), non-protonic ionic liquids, poly(oxyethylene)s, N-methyl-2-pyrrolidone (NMP), and combinations thereof.

Further, the present invention provides an electrochemical device prepared by the afore-described method, which can be any type of device in which electrochemical reactions occur. Specific examples of said electrochemical device include primary and secondary batteries, fuel batteries, solar batteries, and capacitors.

Preferably, the electrochemical device prepared by the afore-described method is an alkaline or alkaline-earth secondary battery, more preferably a Lithium-ion secondary battery.

The cathode which can be used in the present invention can be prepared in a form where a cathode active material is bound to a positive current collector according to a conventional method. Non-limited examples of the cathode active material include conventional cathode active materials known in the art, which can be used in the cathode of the conventional electrochemical devices, as well as lithium-adsorbing materials, such as lithium manganese oxide, lithium cobalt oxide, lithium nickel oxide or composite oxides formed of a combination thereof. Non-limited examples of the positive current collector include foils made of aluminium, nickel or a combination thereof.

Furthermore, the anode which can be used in the present invention can be prepared in a form where an anode active material is bound to a negative current collector in the same manner as in the preparation of the cathode. Non-limited examples of the anode active material include conventional anode active material known in the art, which can be used in the anode of the conventional electrochemical devices, as well as lithium-adsorbing materials, such as lithium alloys, carbon, petroleum coke, graphite or other carbons. Non-limited examples of the negative current collector include foils made of copper, gold, nickel, copper alloy or a combination thereof.

Representative anodes used in the present invention for preparing a secondary battery include the following:
alkaline or alkaline-earth metal, including lithium, sodium, magnesium or calcium;
graphitic carbons able to intercalate alkaline or alkaline-earth metal, typically existing in forms such as powders, flakes, fibers or spheres (for example, mesocarbon microbeads) hosting at least one alkaline or alkaline-earth metal;
alkaline or alkaline-earth metal alloy compositions, including silicon-based alloys, germanium-based alloys;
alkaline or alkaline-earth metal titanates, advantageously suitable for intercalating alkaline or alkaline-earth metal with no induced strain.

### BRIEF DESCRIPTION OF DRAWINGS

FIG. 1 is a plot of discharge capacity (“Q”, in the unit of mAh/g) versus cycle number (“N”) of two coin cell batteries: the open square symbol and the solid triangle symbol were used to represent, respectively, the test results of a reference coin cell using an uncoated separator and the results of a coin cell using a coated separator of the present invention. As indicated by the arrows in FIG. 1, the first two cycles were measured at a discharge rate of C/20, which were subsequently followed by: three cycles measured at a rate of C/10, three cycles measured at a rate of C/5, five cycles measured at a rate of C/3, five cycles measured at a rate of C, and five cycles measured at a rate of 2 C.

### DESCRIPTION OF EMBODIMENTS

The invention will now be described in more detail with reference to the following examples, whose purpose is merely illustrative and not limitative of the scope of the invention.

### EXAMPLES

### Characterization

Wettability Measurement of the Test Separator

The wettability of the test separator will be determined by drop test or capillary test as described below.

(1) Drop Test

A liquid drop (50 μL) of a standard electrolyte solution (SelectiLyte™ LP30: 1 M LiPF6 in EC/DMC 1/1 wt) is deposited by a micropipette on the test separator surface (a disk of 24 mm diameter) for visual observation. After 30 minutes, the electrolyte-wetted area on each test separator surface is photographically recorded for comparison.

(2) Capillary Test

A recipient is filled with 500 μL of an electrolyte solution (1 M LiPF6 in EC/DMC 1/1 wt) or 1M EC/DMC carbonate. A strip of separator film (10×1.5 cm) is hanged right above the solution-filled recipient, with a bottom of 2 mm-height immersed in the electrolyte. Due to capillary force, said electrolyte/carbonate solution gradually climbs up the strip of separator film during the wetting process. After 40 minutes, the solution-wetted height (immersion height) in different test separator strip is measured for comparison.

### Determination of Salt Content in the Separator Coating

The salt content in the separator coating is determined by: first subtracting the original weight of the un-coated separator from the amount weighted for the coated separator to obtain the coating weight, and then, using the known salt: polymer ratio in the coating composition to estimate the actual salt content. Thermo Gravimetric Analysis (TGA) is used to confirm the afore-described calculation of salt content in the separator.

### Determination of Dry Thickness in the Separator Coating

The thickness of a coated/un-coated separator is measured with a micrometer. In addition, a SEM analysis is also performed to precisely determine the coating thickness.

### Example 1

### Preparation of Separator Coated with Polymer and Electrolyte Salt

A homogenous composition consisting of 2 wt % of a VDF-HFP-AA terpolymer and 18 wt % of a LiTFSI salt in acetone solution was applied with a doctor blade to coat a monolayer Tonen F20BMU separator (PE material, 20 μm, 40% porosity, pore size of 0.09 μm), on both sides thereof, to obtain a test Sample No. 1 with a wet coating thickness of about 100 μm. Then, the coated separators were oven dried at a temperature of 80° C. for 30 minutes, and removed from the oven for cooling under the ambient temperature. As a result, a thin coating was produced on the surface of the test separator, having a dry thickness of approximately 2 μm.

### Comparative Example 1

### Preparation of a Separator Coated with Polymer Only

A comparative separator Sample No. 2 was produced in the same manner as Sample 1 in Example 1, except that the homogenous composition only contains 2 wt % of the VDF-HFP-AA terpolymer in acetone solution, without the LiTFSI salt.

### Example 2

### Preparation of Lithium-Ion Battery Using the Polymer/Salt Coated Separator

A lithium half coin cell was assembled using Lithium Iron Phosphate (LiFePO₄) as the cathode active material, acrylic modified PVDF as binder and Super P® carbon black as the conductivity enhancer. The separator Sample No. 1 was assembled between the cathode and anode in the button cell, by a stacking method. Then an electrolyte made of 1M LiPF6 in EC/DMC (1/1 wt) was injected into the button cell structure to produce a final battery. To compare the discharge capacity of the thus assembled battery, a reference coin cell was assembled following the above procedure, except that an un-coated Tonen F20BMU separator was used in place of Sample No. 1 in the cell.

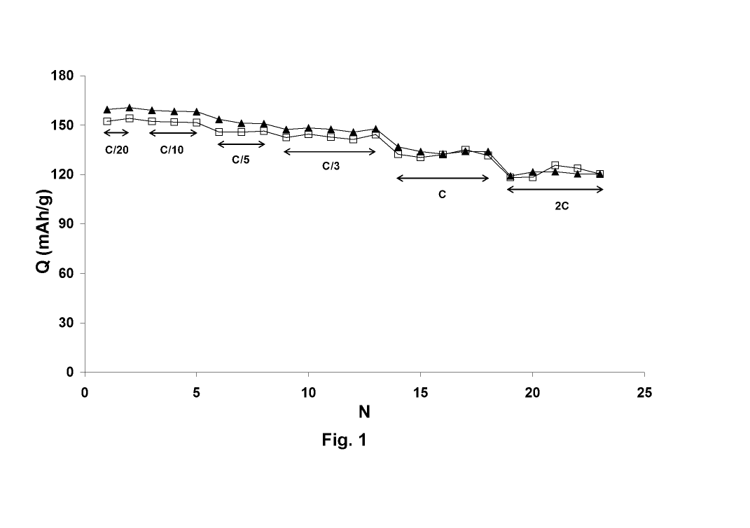

Discharge capacity (“Q”, in the unit of mAh/g) versus cycle number (“N”) of the two coin cell batteries was tested and the results are as shown in FIG. 1. The first two cycles were measured at a discharge rate of C/20, and subsequently followed by: three cycles measured at a rate of C/10, three cycles measured at a rate of C/5, five cycles measured at a rate of C/3, five cycles measured at a rate of C, and five cycles measured at a rate of 2 C (as indicated by arrows in FIG. 1). The symbols of open square and solid triangle were used in FIG. 1 to represent the test results of reference coin cell and the coin cell using Sample No. 1, respectively, for comparison. As shown in FIG. 1, satisfactory discharging characteristics were achieved in the battery assembled using Sample No. 1 according to the present invention.

### Test Example 1

### Evaluation of Wettability of Separator with Electrolyte Using Drop Test

Coated separator Sample No. 1 obtained from Example 1 and Sample No. 2 obtained from comparative Example 1 were evaluated for wettability, using the drop test as described above. Also, an original, uncoated Tonen polyolefin separator was also evaluated for wettability, using the same drop test. The visual observation and photographical record after 30 minutes of test time showed that the separator Sample No. 1 was completely wetted with the electrolyte, while the wetted area for the separator Sample No. 2 was smaller and the original separator was essentially un-wetted.

Accordingly, the separator coated with a polymer and an electrolyte salt according to the present invention (e.g. Sample 1) has shown a superior electrolyte wettability than the original separator, which is even higher than the comparative separator which is coated with the polymer only (e.g. Sample 2).

In use, not only the coated separator of the present invention is wetted much faster, the electrolyte salt contained in the coating can also be advantageously dissolved in the electrolyte injected in the battery assembly, further increasing the internal conductivity thereof.

### Test Example 2

### Evaluation of Wettability of Separator with Electrolytes with Different Salt Concentration Using Capillary Test

Coated separator Sample No. 1 obtained from Example 1 and Sample No. 2 obtained from comparative Example 1 were evaluated for wettability with 1M LiPF₆/EC/DMC electrolyte mixture and 1M EC/DMC carbonate, respectively, using the capillary test described above. Also, an original, uncoated Tonen polyolefin separator was also evaluated for wettability, using the same capillary test. The immersion height was recorded for each separator sample, and listed in Table 1 below, for comparison.

TABLE 1

| | Immersion height in | Immersion height in 1M |
|---|---|---|
| Separator | electrolyte 1M | EC/DMC carbonate |
| Type | LiPF6 (mm) | (mm) |
| Original | 2 | 3 |
| Sample No. 1 | 7.3 | 10.0 |
| Sample No. 2 | 3.5 | 4.5 |

The data in Table 1 again confirmed the superior wettability of the coated separator according to the present invention, as demonstrated by a larger immersion height obtained in separator Sample No. 1 than separator Sample No. 2 with electrolytes of different salt concentration.

Additionally, data in Table 1 also suggest that the salt concentration in an electrolyte solution could potentially affect its wettability for the same separator. As such, since the salt contained in the inventive coated separator per se can be later released to the electrolyte solution after assembly of the electrochemical device, it allows one to use an electrolyte solution with lower salt concentration for filling the electrochemical cell, with the intention to decrease the filling time and increasing its wettability upon contacting the separator. The subsequent release of conductive salt from the coating of the inventive separator to the electrolyte will make up the required level of conductive ion in the cell, thereby optimizing the battery performance. Therefore, the coated separator according to the present invention, which contains both polymer and electrolyte salt in its coating, provides an additional advantage over the existing polymer-coated separators.

### Test Example 3

### Evaluation of Adhesion of Separator Coating Using Peeling Test

A separator Sample No. 3 was produced in the same manner as Sample 1 in Example 1, except that the starting homogenous composition contains 2 wt % of a VDF-HFP-HEA terpolymer and 26.5 wt % of a LiTFSI salt in the acetone solution. Another separator Sample No. 4 was similarly produced, except that the starting homogenous composition contains 2 wt % of a VDF-HFP copolymer and 26.5 wt % of a LiTFSI salt in the acetone solution.

The lab peeling test was carried out on separator Sample No. 3 and No. 4, by measuring the force needed to peel the polymer/salt coating from the Tonen F20BMU separator. The same peeling test was also performed on an original, uncoated Tonen F20BMU separator, as a reference, as shown in Table 2 below.

TABLE 2

| Separator | | Peeling Force |
|---|---|---|
| Type | Coating Composition | (N/m) |
| Original | none | break* |
| Sample No. 3 | VDF-HFP-HEA polymer + | 25.5 |
| | LiTFSI | |
| Sample No. 4 | VDF-HFP polymer + | 9.0 |
| | LiTFSI | |

*The uncoated separator broke internally when the test peeling force was applied thereto

Clearly, as seen from the above comparison, by selecting a VdF polymer which comprises recurring units derived from at least one (meth)acrylic monomer (MA) according to the present invention, the resulted polymer/salt composition advantageously provided a coated separator with improved wettability as well as a superior coating adhesion, compared to other VdF-based polymers.

1. A method for manufacturing a coated separator for use in an electrochemical device, comprising the steps of:
applying a coating composition (C) on at least one surface of a separator having two surfaces, the composition (C) comprising a polymer (P) and at least one electrolyte salt (E) of formula (a),
A⁺B⁻(a)
wherein A⁺ is an ion selected from alkaline metal cations or a combination thereof, and B⁻ is an ion selected from anions or a combination thereof, so as to obtain a coating layer onto said surface; and
drying the coating layer so as to obtain a coated separator,
wherein polymer (P) is a vinylidene fluoride (VdF) polymer and comprises recurring units derived from at least one comonomer (C), said comonomer (C) being different from vinylidene fluoride (VdF),
and wherein polymer (P) comprises recurring units derived from at least one (meth)acrylic monomer (MA) having formula (I): 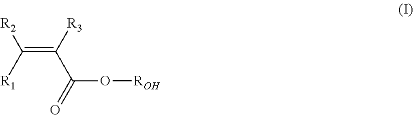
wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group.

2. The method according to claim 1, wherein A⁺ is an ion selected from Li⁺, Na⁺, K⁺ and Cs⁺, or a combination thereof, and
B⁻ is an ion selected from the group consisting of:
(1) PF₆⁻, ClO₄⁻, AsF₆⁺, BF₄⁺, AlCl₄⁻, SbF₆⁻, SCN⁻, C[CF₃SO₂]⁻, CF₃CO₂⁻, AsF₆⁻, B₁₀Cl₁₀⁻;
(2) anions of formula R_{g0}SO₃⁻, wherein R_{g0} is a perfluoroalkyl group having between 1 and 12 carbons;
(3) anions of formula [R_{g1} SO₂][R_{g2}SO₂]N⁻, in which R_{g1} and R_{g2} are equal to or different from each other, each independently a straight or branched perfluoroalkyl group having between 1 and 12 carbons;
(4) B[3,5-[CF₃]₂C₆H₃]₄⁻, B[C₆F₅]₄⁻, Al[OC[CF₃]₃]₄⁻;
(5) difluoro[oxalato]borate (DFOB⁻), bis[oxalato]borate (BOB⁻), tris[oxalato]phosphate (TOP⁻), tetrafluoro[oxalato]phosphate (TFO⁻), [C₂F₅]₃PF₃⁻ (FAP⁻), B[CN]₄⁻ (Bison⁻), 4,5-dicyano-[2-trifluoromethyl]imidazolide (TDI⁻);
and combinations thereof.

3. The method according to claim 1, wherein salt (E) is selected from lithium bis(trifluoromethanesulfonyl)imide (LiTFSI) and lithium bis(fluorosulfonyl)imide (LiFSI).

4. The method according to claim 1, wherein composition (C) comprises polymer (P) and at least one salt (E) in a solvent (S), and wherein the coating layer is dried by volatilization of the solvent (S).

5. The method according to claim 4, wherein solvent (S) is selected from the group consisting of: acetone, methylethylketone, methylene choloride/methanol mixtures, tetrahydrofuran (THF), methylene chloride, chloroform, dimethylformamide (DMF), N-methyl-2-pyrrolidone (NMP), cyclohexane, water and mixtures thereof.

6. The method according to claim 1, wherein composition (C) comprises an amount of salt (E) of from about 25 to about 250% by weight, based on the weight of polymer (P).

7. A separator for use in an electrochemical device, said separator being coated on at least one surface thereof with a coating comprising a polymer (P and at least one electrolyte salt (E) of formula (a),
A⁺B⁻(a)
wherein A⁺ is an ion selected from alkaline metal cations or a combination thereof, and B⁻ is an ion selected from anions or a combination thereof, wherein polymer (P) is a vinylidene fluoride (VdF) polymer and comprises recurring units derived from at least one comonomer (C), said comonomer (C) being different from vinylidene fluoride (VdF),
and wherein polymer (P) comprises recurring units derived from at least one (meth)acrylic monomer (MA) having formula (I): 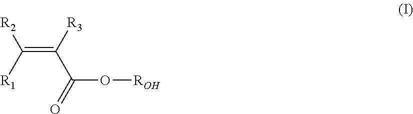
wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group, and wherein said coating has at least one of the following properties:
(a) a dry thickness of from about 0.1 to 10 μm;
(b) a weight that is between 5 and 100% of the weight of the un-coated separator; or
(c) is substantially solvent free.

8. The separator according to claim 7,
wherein the coating has a weight that is between 10 and 50% of the weight of the un-coated separator.

9. The separator according to claim 7,
wherein said coating has a dry thickness of from about 1 to 5 μm.

10. A separator according to claim 7, wherein the separator is a porous separator.

11. A method for producing an electrochemical device, the method comprising:
applying a coating composition (C) on at least one surface of a separator having two surfaces, so as to obtain a coated separator, wherein composition (C) comprises a polymer (P) and at least one electrolyte salt [E] of formula (a),
A⁺B⁻(a)
wherein A⁺ is an ion selected from alkaline metal cations or a combination thereof, and B⁻ is an ion selected from anions or a combination thereof, and wherein polymer (P) is a vinylidene fluoride (VdF) polymer and comprises recurring units derived from at least one comonomer (C), said comonomer (C) being different from vinylidene fluoride (VdF),
and wherein polymer (P) comprises recurring units derived from at least one (meth)acrylic monomer (MA) having formula (I): 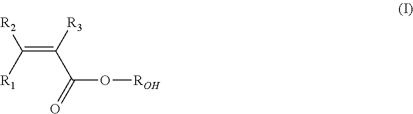
wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group;
interposing the coated separator between a cathode and an anode to produce an electrochemical device; and,
injecting an electrolyte into the electrochemical device.

12. A method according to claim 11, wherein the electrochemical device is an alkaline or alkaline-earth secondary battery.

13. A method according to claim 12, wherein the electrochemical device is a Lithium-ion secondary battery.

14. The method according to claim 6, wherein composition (C) comprises an amount of salt (E) of from about 50 to about 150% by weight, based on the weight of polymer (P).

15. The method according to claim 6, wherein composition (C) comprises an amount of salt (E) of from about 100 to about 200% by weight, based on the weight of polymer (P).

16. The method according to claim 1, wherein the (meth)acrylic monomer (MA) is a monomer of formula (II): 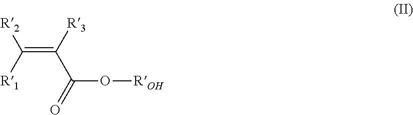
wherein:
R′₁, R′₂ and R′₃ are hydrogen atoms, and
R′_{OH} is a hydrogen atom or a C₁-C₅ hydrocarbon moiety comprising at least one hydroxyl group.

17. The method according to claim 1, wherein the (meth)acrylic monomer (MA) is selected from:
hydroxyethyl acrylate (HEA) of formula: 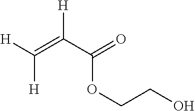
2-hydroxypropyl acrylate (HPA) of either of formulae: 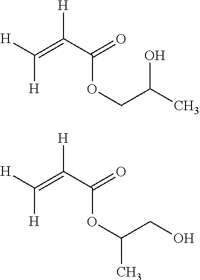
acrylic acid (AA) of formula: 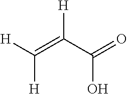
and mixtures thereof.
